(19) United States
(12) Patent Application Publication
(10) Pub. No.: US 2006/0124232 A1
(43) Pub. Date: Jun. 15, 2006

(54) Method and apparatus for applying a film to a container stopper

(75) Inventors: Nicholas Barson Mebberson, Victoria (AU); Anthony Barson Mebberson, Victoria (AU)

Correspondence Address: CONNOLLY BOVE LODGE & HUTZ LLP, SUITE 800, 1990 M STREET NW, WASHINGTON, DC, 20036-3425, US

(73) Assignee: Procork Pty Ltd, Melbourne (AU)

(21) Appl. No.: 10/541,582

(22) PCT Filed: Jan. 6, 2004
(86) PCT No.: PCT/AU04/00003

§ 371 Date: Jul. 7, 2005

(30) Foreign Application Priority Data
Jan. 7, 2003 (AU) 2003900034

(51) Int. Cl. B32B 37/00

(52) U.S. Cl. 156/256; 156/517

(57) ABSTRACT

A method of applying a film coating to an end of a container stopper (1) including the steps of: (a) positioning the stopper (1) with the said end adjacent a web (31) of film, (b) cutting from the web (31) a portion of film sized to suit said end of the stopper (1) and (c) bonding the film portion to the end of the stopper (1).

### TECHNICAL FIELD

The present invention concerns the provision of an improved container stopper for stoppering an opening in a container. More particularly, the present invention relates to a method of applying a film to an end of a container stopper. The present invention also relates to an apparatus for carrying out such a method.

A number of products are packaged in containers where the opening in the container is sealed using a stopper. In these circumstances, the stopper typically forms an interference fit within the container opening. One of the most common examples of a packaged product that uses such a stopper is wine, although other beverages and edible oils are also common examples. The method and apparatus of the present invention have particular application to such cork-type stoppers typically associated with bottles of wine and oil, although it will be appreciated that the invention is not limited to this particular type of container stopper, but may have application in other fields.

### BACKGROUND

Wine is traditionally packaged in bottles that are sealed with cork stoppers. Stoppers made form cork have historically been used in the wine industry for a variety of reasons, most of which relate to the natural qualities of the cork that make it suitable for this purpose. By way of example, cork as a material is durable, resilient, free from rotting, is permeable to gas, is predominantly waterproof, is readily compressible and is easy to shape into a variety of desired conformations.

A disadvantage of using cork stoppers, however, is that they can lead to the development of undesirable scent and flavour characteristics in the packaged product. In particular, cork is known to be a cause of musty or mouldy taint in wine, and sometimes a cause of ‘off’ flavours due to oxidation. Indeed, it is estimated that approximately five percent of wines are affected in this way. In 1994 the Quercus project was initiated by the European cork industry to reduce the occurrence of poor or ‘off’ flavours. TCA (2,4,6 Trichloroanisole) has been identified as the cause of some musty/mouldy taint. Although cork is not the only source of TCA in wine, it has been shown that some corks contain levels of TCA that are transferred to wine when stored in bottles. It has also been observed that the taints can be transferred to the wine via vapour when the bottles are left standing up and the liquid does not contact the cork surface. This is due to cork's poor barrier to volatile materials, demonstrated by its readiness to absorb and desorb moisture vapour with changes in relative humidity, its susceptibility to the entry of the volatiles which may be retained and later transferred to wine.

Another consideration is whether the product needs to be completely sealed off from the environment or whether gaseous exchange is desirable to improve the characteristics of the product. With bottle storage of wine, for example, flavour development of the wine with aging has to be taken into account. Although the concept of bottle aging, bottle maturation or bottle development is well known, it is in fact little understood or scientifically proven. There is some belief that the stopper breathes and that oxygen plays a role in bottle development of the wine, although it is well proven that too much oxygen will oxidise a wine and ruin it. There is a growing body of work that is, developing the use of micro-oxygenation to develop flavour and mature wines. Any stopper for use in the wine industry therefore should be permeable to some extent to allow some oxygen to permeate the stopper and come into contact with the wine.

A number of approaches have been developed aimed at overcoming the problems of contamination of the product by the stopper whilst at the same time retaining the oxygen permeability characteristic. For example, it has been shown that coatings can be used to improve the performance of cork stoppers. Waxes and paraffins may be used as coating and applied to corks to improve the sealing capability. If this is done, paraffins are usually used in solid, oil or emulsion form. It has also been observed that wax coatings can reduce the amount of liquid that soaks into the cork over time. Silicone coatings have also been applied to corks to improve the insertion and extraction of the cork. It is thought that the silicone reduces the friction between the cork and the bottle during both the insertion and extraction processes. Coatings of this type are typically applied to the corks while the corks are tumbling in a rotating drum. The corks may be tumbled with a solid wax block or a liquid is squirted or otherwise sprayed onto corks. The coating is then spread from cork to cork by the physical contact between the corks transferring the coating and evenly distributing it. Heat may also be applied to aid the process.

There have been attempts to place other types of physical barriers between the stopper and the wine to prevent the transmission of tainting components to the wine. Several of these attempts have worked on the principle of applying a coating layer in the form of a polymeric film to the end of the stopper. However, the characteristics of the stoppers produced using prior techniques have not always been satisfactory. Without wishing to be bound by theory it is thought that the problem with these approaches is that whilst the stopper is compressible (as required for insertion into the neck of the bottle) the coating layer is typically not compressible. This leads to the development of imperfections in the coating layer such as cracking, peeling, creasing and the like.

Patent application WO 00/34140 purports to overcome these problems and describes a composite stopper with a body and a thick moulded elastomer plug at the end of the stopper in contact with the wine. The elastomer plug acts to seal the bottle and is claimed to be a taint barrier. While this approach may overcome the problems of taint, it does have its drawbacks. For example, the unit cost of each stopper is significantly higher than the unit cost of cork stoppers in general, and so is undesirable from an economic standpoint. In addition, elastomer plugs of the type described have a high inherent transmission rate for oxygen and tainting molecules such as TCA, thereby requiring the plug to be thick to achieve the required oxygen and taint barrier properties for desirable bottle aging and taint reduction. Further, as the exact orientation of the stopper into the opening of the container is crucial for proper performance of this particular stopper, expensive capping machinery is typically required to ensure adequate performance of the stopper once fitted.

It would therefore be desirable to provide an improved stopper for a container that overcomes or substantially ameliorates the problems associated with contamination of the contents of the container, whilst preferably still allowing for oxygen transmission through the stopper. The present invention aims in particular to provide a new method and apparatus for producing such an improved stopper.

### SUMMARY OF THE INVENTION

According to one aspect, the present invention provides a method of applying a film coating to an end of a container stopper. Broadly, the method includes the steps of: positioning the stopper with the said end adjacent a web of film; cutting from the web a portion of film sized to suit said end of the stopper; and bonding the film portion to the end of the stopper.

In a preferred embodiment of the invention, the step of positioning the stopper with the said end adjacent the web of film includes transporting or conveying the stopper to such a position. This step may also include orienting the stopper such that the end is adjacent the film web.

In a preferred embodiment of the invention, the step of bonding the film portion to the end of the stopper includes the step of applying heat over substantially the entire area of the film portion to activate adhesive properties of the film and pressing the heated film portion and the end of the stopper into contact with one another.

In an alternative embodiment of the invention, the step of bonding the film portion to the end of the stopper includes the step of applying adhesive to the end of the stopper and subsequently pressing the film portion and the end of the stopper into contact with one another. The adhesive may be a hot-melt adhesive, and it may be applied to the end of the stopper prior to the portion of film being cut from the web. Alternatively, the hot-melt adhesive may be applied to the film—for example, by spraying or extrusion coating.

Although other shapes are contemplated by the present invention, the stopper will usually have a cylindrically shaped body. Accordingly, the end of the stopper will usually have a generally circular cross-sectional configuration and present a generally planar end surface. The end of the stopper may not be entirely planar, however. For example, a peripheral edge region at the end of the stopper may be tapered or chamfered, and/or the end may have a stepped configuration.

In a preferred embodiment of the invention, the portion of film cut from the web is sized and shaped to substantially entirely cover the end of the stopper, and preferably without any excess of film.

In a preferred embodiment of the invention, the pressing of the film portion and the end of the stopper into contact with one another during the film-bonding step involves the use of a press or mandrel shaped to complement the geometry of the end of the stopper. Accordingly, the bonding press/mandrel preferably has a recess for receiving the end of the stopper, with the recess shaped to correspond to the three-dimensional geometry of the end of the stopper. The bonding press or mandrel is also preferably heated.

In a preferred embodiment of the invention, the method includes the step of curing the bond between film portion and the end of the stopper. This step of curing the bond typically involves cooling the film portion and the end of the stopper to set the bond and ensure proper adhesion there-between. The cooling of the film portion and the end of the stopper also typically occurs while pressing the film portion and the end of the stopper into contact with one another. The pressing of the film portion and the end of the stopper into contact with one another during this curing step involves the use of a press or mandrel shaped to define the geometry of the end of the stopper. Thus, the curing press/mandrel may also have a recess for receiving the end of the stopper, with the recess shaped to correspond to either' the current or a desired three-dimensional geometry of the end of the stopper. That is, the recess may be shaped differently from the end of the stopper, such that when the bond between the film and the stopper end sets under the press/mandrel of the curing head, the stopper end is permanently deformed to the desired shape of the recess. The curing press/mandrel is preferably cooled.

In a preferred embodiment of the invention, the step of cutting the film portion from the web includes the step of fixing the film portion relative to the end of the stopper. The step of fixing the film portion relative to the end of the stopper preferably comprises adhesively tacking the cut portion of the film to the end of the stopper over at least part of the area of the film portion. This step of adhesively tacking the film portion to the end of the stopper preferably includes applying heat to and pressing said part of the film portion into contact with the end of the stopper, with the application of heat desirably activating adhesive properties of the film portion. Alternatively, however, the step of adhesively tacking the film portion to the end of the stopper may include applying an adhesive substance to the end of the stopper and pressing the at least part of the film portion into contact therewith.

In a preferred embodiment of the invention, the container stopper has a substantially cylindrical body having two opposite ends, and the method includes the step of applying a film coating to each of said two ends of the stopper, at substantially the same time. That is, the method of the present invention is carried out at each of the two ends of the stopper body substantially simultaneously.

In another alternative preferred embodiment of the invention, the container stopper has a substantially cylindrical body having two opposite ends, and the method includes the step of applying a film coating to one of said two ends of the stopper, inverting the stopper and then applying a film coating to the other of said two ends of the stopper. The step of inverting the container stopper preferably includes returning the stopper to a starting position for the method.

In one form of the invention, the film portion may be pre-cut from the film web to be applied to the end of the stopper as a, for example, disc-like label that is then subsequently bonded. Therefore, according to an alternative aspect, the present invention provides a method of applying a film coating to an end of a container stopper including the steps of: providing a stopper having at least one end to be coated; cutting from a web of film a portion of film sized to suit said end of the stopper; applying the cut film portion to the end of the stopper; and bonding the film portion to the end of the stopper.

According to another aspect, the present invention provides a container stopper having a film coating applied to at least one end thereof according to the method of the invention as described above.

Thus, the container stopper of the invention typically comprises a body of compressible material having at least one end for insertion into an opening of a container, and a film on said at least one end of the body of compressible material for providing a protective barrier between the compressible material and the container contents. The compressible material of the stopper is preferably selected from the group consisting of: natural cork, agglomerated cork and micro-agglomerated cork. Of course, a polymeric material such as a medium density or low density closed-cell foamed plastic (as disclosed in U.S. Pat. No. 6,355,320) could also be used, as could a number of fibrous materials (as disclosed in U.S. Pat. No. 5,665,462). The end of the body of compressible material is preferably such that, upon compression of the body for insertion into an opening of a container, the protective barrier provided by the film suffers substantially no adverse affects.

In yet another aspect, the present invention provides a packaged product comprising a liquid in a container, such as a bottle. The container includes a container stopper according to the invention, with the container stopper received in a neck of the container in an interference fit to thereby seal a container opening.

According to a further aspect, the present invention also provides an apparatus for applying a film coating to an end of a container stopper. Broadly, the apparatus includes: means for positioning the stopper with the said end thereof adjacent a web of film; means for cutting from the web a portion of film that is sized to suit the end of the stopper; and means for bonding the film portion to the end of the stopper.

In a preferred embodiment of the invention, the positioning means includes conveyor means for transporting the stopper to a position adjacent the web of film. The conveyor means preferably includes a carriage for holding one or more of the stoppers and transporting the stopper(s) therein. More preferably, the conveyor means includes a plurality of carriages, each of which is adapted to hold a group of stoppers. Each stopper is typically held in a carriage with the end to be coated facing the film web. The conveyor means may be in the form of an endless belt or endless chain type conveyor. Alternatively, the conveyor means may be in the form of a rotary table or drum. The conveyor means of the apparatus is furthermore preferably adapted to transport the stoppers from the cutting position adjacent the web of film to the bonding means.

In a preferred embodiment of the invention, the apparatus includes loading means for loading the stoppers into each carriage on the conveyor means. The loading means preferably includes a bulk container, such as a hopper, adapted to channel or direct stoppers into holding receptacles in each carriage.

In a preferred embodiment of the invention, the cutting means includes a cutting edge that defines the size and shape of the film portion to be cut from the web. The cutting edge is preferably in the form of a blade or knife edge, but a cutting die is also contemplated by the present invention. The cutting edge is movable relative to the film web, and the cutting means preferably also includes a surface against which the blade or knife edge bears as the film portion is cut from the web. The cutting means also preferably includes a recess adapted to receive said end of the stopper for locating the end relative to the cutting edge during cutting of the film. The web of film is typically provided on a spool, and the spool is advanced after each cutting operation to provide a fresh film web for the next cutting operation.

In a preferred embodiment of the invention, the cutting means includes means for fixing the cut film portion relative to the end of the stopper. This means for fixing the film portion relative to the end of the stopper typically comprises means for adhesively tacking the film portion to the end of the stopper over at least part of the area of the film portion.

Although the tacking means could conceivably comprise a mechanism that applies an adhesive substance to the end of the stopper and presses at least part of the film portion into contact therewith, it more preferably comprises a mechanism for applying heat to part of the film portion to activate adhesive properties of the film and pressing the heated film portion into contact with the end of the stopper. Accordingly, the tacking mechanism preferably includes a heated tacking head, which is movable to contact at least part of the film and to press that part of the film into contact with the end of the stopper. The tacking head preferably acts substantially simultaneously with the cutting edge.

In a preferred embodiment of the invention, the position of the heated tacking head is adjustable, for example relative to the cutting edge of the blade or knife, such that it becomes possible to make slight variations in the diameter of the film portion disc cut from the web. When the heated tacking head contacts the film, the degree of projection of the tacking head beyond the cutting edge influences the size of the film portion that is ultimately cut from the film web. Accordingly, adjustments in this projection of the tacking head can be used to vary the size of the cut film portion.

In a preferred embodiment of the invention, the means for bonding the cut film portion to the end of the stopper includes means for applying heat over substantially the entire area of the cut film portion to activate adhesive properties of the film and means for pressing the heated film portion and the end of the stopper into contact with one another. The bonding means therefore preferably includes a heated bonding head in the form of a press or mandrel adapted to apply pressure against the end of the stopper with the film at least partially affixed thereto. The bonding head is preferably provided with a recess adapted to receive the end of the stopper, and the recess is preferably sized and shaped to complement the geometry of the stopper end. The bonding head may be movable relative to the stoppers sitting in each carriage, or vice versa.

In an alternative embodiment of the invention, the bonding means may comprise means for applying adhesive to the end of the stopper and subsequently pressing the film portion and the end of the stopper into contact with one another. For example, the adhesive could be a hot-melt adhesive, and this adhesive could be applied to the end of the stopper prior to the film portion being cut from the web.

In a preferred embodiment of the invention, the cutting means and the bonding means may be combined in a single operating head. For example, if the cutting edge is provided on a cutting die, the base of the cutting die itself could also simultaneously function as the bonding means. That is, the base of the cutting die could be provided with a shaped recess and be heated, and be designed to press the cut film portion into bonding contact with the end of the stopper body just as the die cuts the film portion from the web.

In a preferred embodiment of the invention, the apparatus includes means for curing the bond between film portion and the end of the stopper. This bond curing means is adapted to cool the film portion and the end of the stopper to set the bond and ensure proper adhesion there-between. The cooling of the film portion and the end of the stopper preferably occurs under pressure, i.e. while pressing the film portion and the end of the stopper into contact with one another. Accordingly, as with the bonding head, the curing head is preferably in the form of a press or mandrel shaped to complement the geometry of the end of the stopper. Thus, the curing head press/mandrel also recesses for receiving the ends of the stoppers, with the recesses sized and shaped to correspond to the three-dimensional geometry of the end of the stopper. The curing head press/mandrel is also preferably cooled.

The curing head recesses could alternatively be shaped to deform the end of the stopper into a somewhat different configuration. That is, the recess may be shaped to correspond to a desired three-dimensional geometry of the end of the stopper. In other words, the recess may be shaped differently from the end of the stopper, such that when the bond between the film and the stopper end sets under the pressure of the curing head, the stopper end is permanently deformed to the desired shape of the recess.

As already mentioned above, each container stopper preferably has a substantially cylindrical body having two opposite ends. The apparatus of the invention preferably includes means for inverting each stopper and then applying a film coating to the other of said two ends of the stopper. The inverting means preferably comprises a mechanism for extracting the container stoppers from their conveyor means carriage and returning the stoppers to a starting position in a different carriage.

Alternatively, each of the stoppers may be held in its carriage in such a way that both ends of the stopper project prominently enough for the apparatus of the invention to apply a coating of film to each of those ends simultaneously. Thus, the apparatus of the invention may adapted to operate on each of the opposite ends of the stopper bodies substantially simultaneously.

In a preferred embodiment of the invention, the conveyor means is adapted to eject the stoppers to a bulk container after the application of the film coating to the end(s) thereof is completed.

### BRIEF DESCRIPTION OF THE DRAWINGS

For assistance in arriving at a better understanding of the present invention, an example of a method and apparatus according to a preferred embodiment of the invention is hereafter described with reference to the accompanying drawings. The preceding description may also be read with reference to those drawings. However, it should be understood that the drawings are not intended to limit the generality of the preceding description.

In the drawings, like reference numerals designate like features and:

FIG. 1 shows a schematic layout in side view of an apparatus according to a preferred embodiment of the invention;

FIG. 2 shows a schematic layout in plan view of the apparatus in FIG. 1;

FIGS. 3a to 3c show details in sectioned side views of the cutting operation of FIG. 1; and

FIG. 4 shows detail in sectioned side view of the bonding operation of FIG. 1.

FIGS. 5a to 9d show details of an apparatus according to a second preferred embodiment of the invention. In particular,

FIGS. 5a to 5c show details in plan view a transport carriage according to the second preferred embodiment of the invention;

FIG. 5d is a close up of the transport carriage of FIG. 5c;

FIG. 5e is a sectional side view of the transport carriage of FIG. 5d;

FIG. 5f is a close up of the transport carriage of FIG. 5a;

FIG. 5g is a sectional side view of the transport carriage of FIG. 5f;

FIG. 6 shows details in a front view a cutting operation according to the second preferred embodiment of the invention;

FIG. 7a is a front view of a portion the cutting operation of FIG. 6;

FIG. 7b is a plan view of FIG. 7a;

FIG. 7c is a side view of FIG. 7a;

FIG. 7d is a close up of a portion of the cutting operation of FIG. 7a;

FIG. 8a is a front view of another portion the cutting operation of FIG. 6;

FIG. 8b is a plan view of FIG. 8a;

FIG. 8c is a side view of FIG. 8a;

FIG. 8d is a close up of a portion of the cutting operation of FIG. 8a;

FIG. 9a shows details in a front view a bonding operation according to the second preferred embodiment of the invention;

FIG. 9b is a plan view of the bonding operation of FIG. 9a;

FIG. 9c is a side view of the bonding operation of FIG. 9a;

FIG. 9d is a close up of FIG. 9b;

FIG. 9e is a close up of FIG. 9a;

FIG. 9f is a close up of FIG. 9c;

### DETAILED DESCRIPTION OF THE PREFERRED EMBODIMENTS

In the wine industry, bottling operations typically utilise high speed stoppering machines which subject the cork-type stoppers to large compression forces. These machines typically have a number of compression jaws, which radially compress the stopper from its normal diameter to about one third of its original size. The machines then employ a ram to force the compressed stoppers directly into the bottle openings where the stoppers expand creating a tight interference fit in the neck of the bottles, and thus seal the bottle.

Naturally, therefore, the stoppers for use in the apparatus and method of the present invention should have a compressible body. It is preferred that the stopper body be formed of a material that can be compressed by at least 5 percent, more preferably by at least 10 percent, even more preferably by at least 20 percent, and preferably by at least 30 percent. A number of materials having these properties may be used. Most preferably, however, the stoppers produced with the present invention have bodies formed from natural cork, agglomerated cork, micro-agglomerated cork, or a combination thereof.

The stoppers are usually elongate and may have any of a variety of cross-sectional shapes, with the shape of the stopper essentially being determined by the shape of the opening it is intended to seal. As mentioned previously, however, the stoppers will most typically have a generally cylindrical body and the end of the stopper will usually have a generally circular cross-sectional configuration for insertion into the container opening. The end of the stopper may not be entirely planar, however. For example, a peripheral edge region at the end of the stopper may be tapered or chamfered, and/or the end may have a stepped configuration.

The method and apparatus of the present invention concern the application of a film coating to the stopper, and the film itself is preferably a polymeric film. The polymeric film desirably has multiple layers and includes an outer barrier layer and an inner adhesive layer.

The barrier layer preferably has a low permeability to hydrogen, oxygen and carbon dioxide, and is substantially impermeable to organic molecules with molecular weights greater than 40. A number of barrier layers are known in the art that can be utilised to achieve this result. Preferably, the barrier layer includes one or more polymers selected from the group consisting of polyethylene and copolymers thereof, polypropylene and copolymers thereof, polyethylene Terepthalate and copolymers thereof, ethylene-vinyl acetate and polyvinyl acetate and copolymers thereof, ethylene acrylic acetate, ethylene acetic alcohol, polyvinylchloride and copolymers thereof, polydivinylchloride and copolymers thereof, polyvinyidichloride and copolymers thereof, polyvinylacetate and copolymers thereof, ethylene vinyl alcohol and polyvinyl alcohol and copolymers thereof, polyurethane and copolymers thereof, polyacrylonitrile and copolymers thereof, cellophane, polyamines, polycarbonates, polystyrene and copolymers thereof, polyalkylene oxides and copolymers thereof, polyethylene oxides and copolymers thereof, cellulose, cellulose derivatives, and metal, aluminium oxide, silica and silicon polymers. A preferred barrier film has a multi-layer structure and includes PVDC, PDVC, EVOH, EM or metal.

The barrier layer preferably has a thickness in the range of 1 to 50 micron, more preferably in the range of 2 to 20 micron, and most preferably in the range of 5 to 15 micron.

The adhesive layer may be laminated to the barrier layer, or it may be added to the film or the cork by way of a spray or extrusion. Suitable adhesive layers include heat activated adhesive compounds (eg in a laminated layer) and hot-melt adhesive compounds (eg applied to the film as a spray or extrusion). Suitable adhesive compounds therefore include ethylene vinyl acetate, polyamides, acrylics, methyl methacrylate based polymers, starch based adhesive, carbohydrate based adhesives, protein based adhesives, animal glues, rubber, silicone, epoxy, melamine-formaldehyde based, unsaturated polyesters, urea-formaldehyde resins, resorcinol, phenolic, anaerobic adhesives, urethanes, polysulfides, polyvinyl and ethylene vinyl acetates, ethylene acrylic acetate, and ethylene acetic alcohol. Particularly preferred adhesives are ethylene vinyl acetate homopolymer or co-polymer or modified ethylene vinyl acetate.

The adhesive layer preferably has a thickness in the range of 0.1 to 10 micron, and more preferably in the range of 1 to 5 micron. If a heat activated adhesive is used, it preferably has an activation temperature greater than about 40° C., more preferably greater than about 60° C., and most preferably greater than about 80° C. Yet more preferably the activation temperature is between 120° C. and 190° C.

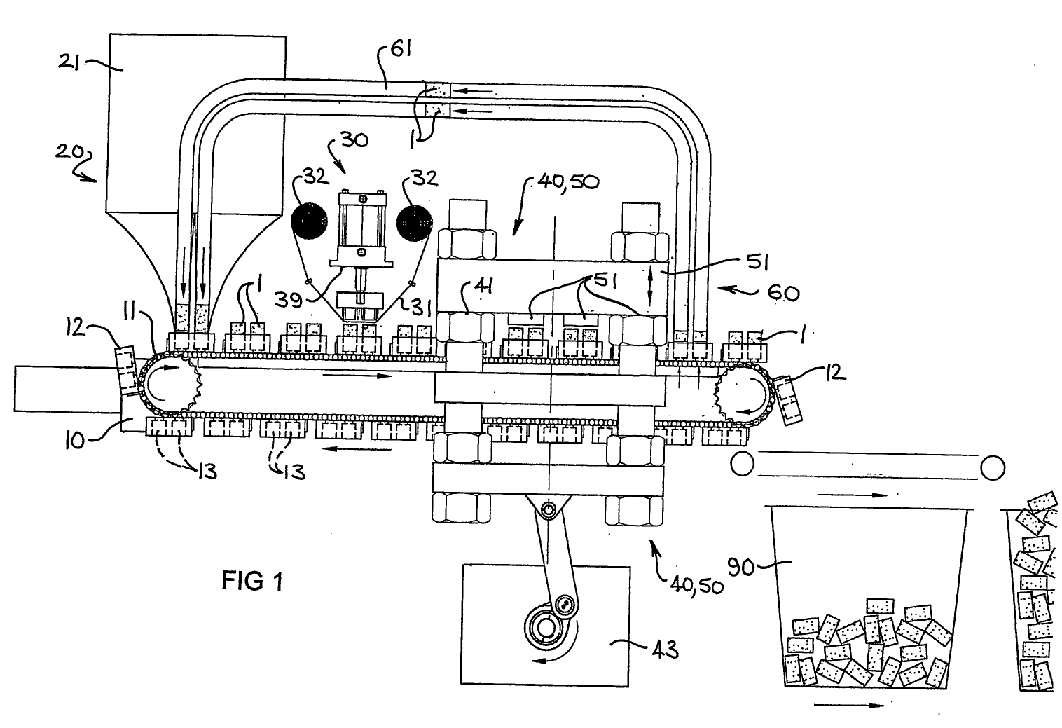

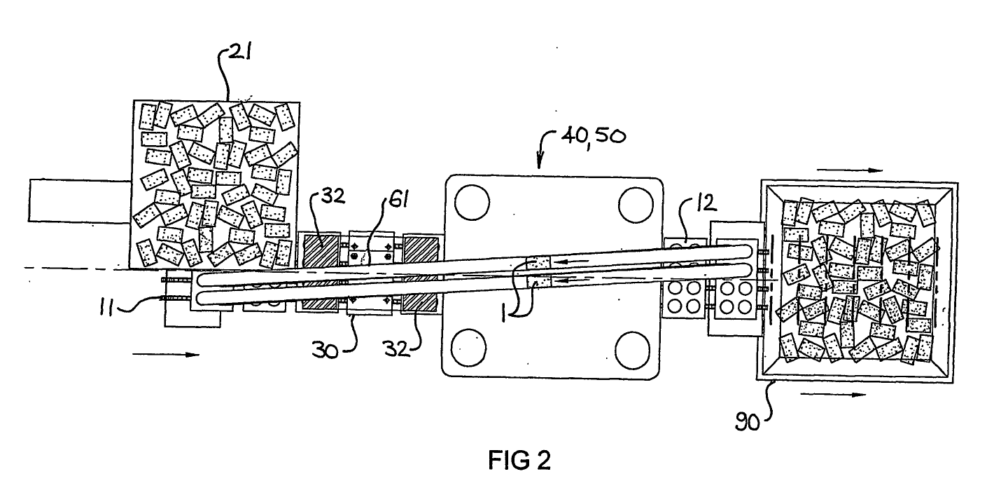

Referring now to FIGS. 1 and 2 of the drawings, an example of an apparatus (100) according to a preferred embodiment of the invention is schematically illustrated. The apparatus (100) includes linear conveyor means (10) for transporting cork stoppers (1) through the apparatus. The conveyor means (10) includes a chain conveyor (11) having a plurality of transport carriages (12) mounted thereon. Each of the carriages (12) defines eight holding receptacles (13), each of which is designed to receive a single stopper (1). The chain conveyor (11) is motor-driven via chain wheels (14) in the direction shown by the arrows. More particularly, the chain conveyor is driven in an indexed or step-wise fashion in order to transport the stopper carriages (12) to precise positions within the apparatus at specific time intervals.

A loading device (20) is also provided for loading the stoppers (1) into the carriages (12) on the chain conveyor. The loading device (20) includes a hopper (21), which tapers at the bottom to channel or direct the stoppers into the separate holding receptacles (13) of each carriage. This hopper (21) will typically be automatically controlled and operated via a motor (22) to dispense the cork stoppers to the carriages (12) at specific intervals. Some suitable sensor may be provided to signal the dispensing mechanism that the next carriage is in place and ready to receive corks from the hopper. The loading device (20) is designed to fill four of the eight holding receptacles (13) in each of the carriages. The other four receptacles are filled by a cork-return device, as will be described later.

The apparatus (100) also includes a device (30) designed to cut portions of film from a film web (31), with each of those cut film portions being sized and shaped to suit the upstanding ends of the cork stoppers held in the carriages (12). The film web (31) is provided on spools (32), and during operation of the apparatus is advanced from one spool of new film to the other spool of spent or used film as the individual film portions are cut from the web. The cutting device (30) has a cutting head (33) that includes eight circular knives or blades (34), with each knife or blade associated with a separate one of the cork stoppers (1) in the carriage (12) adjacent to the cutting device (30).

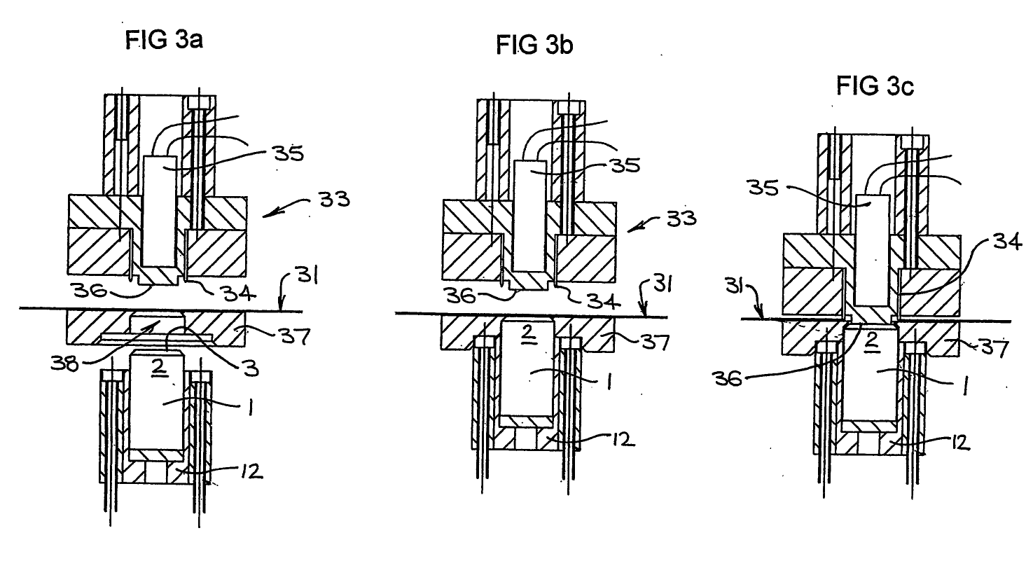

With reference now to FIGS. 3a to 3c of the drawings, the cutting device (30) will be described in greater detail. FIGS. 3a to 3c show the sequence of events associated with the cutting of the film web (31) at each of the cutting blades or knives (34) associated with an individual cork stopper. Referring firstly to FIG. 3a, the generally cylindrical cork stopper (1) is held centrally in its receptacle in the carriage (12). The stopper (1) has an upstanding end (2) which is slightly tapered due to a chamfered peripheral edge region and which presents a substantially flat upper surface (3). The cutting head (33) illustrated in FIG. 3a has a circular knife or blade (34) for cutting a disc film portion from the film web (31), with the disc-shaped film portion being sized to substantially entirely cover the tapered end of the cork. The cutting head also includes an electrical heating element (35) for heating an end face (36) of the cutting head.

The film web (31) extends between the end (2) of the cork and the cutting head (33). A cutting plate (37) supports the film web and provides a surface against which the knife or blade (34) may bear as the disc-like film portion is cut from the web. This cutting plate (37) includes a recess (38) adapted to receive the end of the cork for locating the end (2) relative to the knife or blade during cutting of the film.

As can be seen in FIGS. 3a to 3c, the carriage (12) is moved upwards to locate the tapered end (2) of the cork within the recess (38) next to the web of film (31). The pneumatic cylinder (39) then drives the cutting head (33) down towards the end of the cork such that the circular knife (34) cuts a disc-like film portion from the film web. At the same time, the heated end face (36) of the cutting head (33) presses the disc-like film portion into contact with the flat uppermost surface (3) at the end of the cork (1). This application of heat and pressure activates the adhesive properties of the inner layer of the polymer film to thereby fix the cut film portion disc (not shown) relative to the end of the cork by adhesive tacking. The tacking process is preferably undertaken at a temperature of between 90° C. and 135° C. The end (2) of the cork will typically undergo some compression during this heat-tacking operation and the degree of compression will typically depend on the extent to which the heated projecting end face (36) of the cutting head is pressed down into the recess (38). This pressing of the end face (36) down into the recess also affects the size of the film portion that is ultimately cut from the film web. The size of the end face (36) and/or its extent of downwards descent may preferably be able to be adjusted or manipulated to make slight adjustments in the diameter of the film portion disc cut from the web. Once the cutting head (33) and the cork stopper (1) are again withdrawn from the cutting plate (37) to the position shown in FIG. 3a, the stopper (1) will have a disc-shaped portion of film (not shown) fixed to its end (2) ready for final bonding.

With reference again now to FIG. 1 of the drawings, it will be seen that the apparatus also includes a combined bonding and curing press (40, 50). This bonding/curing press has a heated bonding head (41) and three cooled curing heads (51). The press is reciprocally driven by a crank mechanism (43).

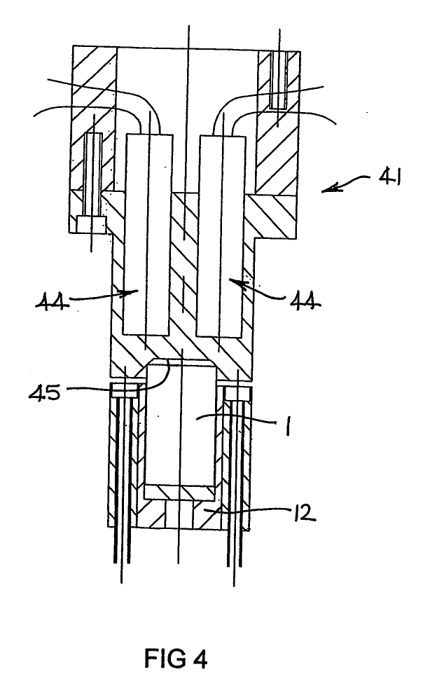

Detail of the bonding head (41) is shown in FIG. 4 of the drawings. The bonding head includes electric heating elements (44) and a shaped recess (45) adapted to receive the tapered end (2) of the cork stopper. The shaped recess (45) is designed with substantially the same angle of taper as the end of the cork. The crank drive mechanism (43) moves the heated bonding head (41) downwards such that each of the cork ends (2) is received within a respective one of the bonding head recesses (45) and such that the heated bonding head presses the cut film portion disc—which is fixed at the upper end of each of the corks—into intimate contact with the cork over the entire extent of the film portion. In so doing, the cork will typically experience some compression, e.g. in the range of about 5 to 10 percent, and will be held for a period in the range of about 0.1 to 15 seconds, and more preferably in the range of about 0.1 to 5 seconds. During this period, the film portion and the end of the cork are typically heated to at least 80° C., and more preferably to at least about 120° C. Yet more preferably, the film portion and the end of the cork are heated to between 120° C. and 190° C. This heating again activates the adhesive properties of the film over the entire area of the disc-shaped cut portion and presses the film into intimate contact with the tapered end (2) of the cork stopper (1), enabling the film to bond coherently and consistently over the entire tapered end.

The three cooling heads (51) also have recesses (not shown) for receiving the ends (2) of each cork stopper in the adjacent carriages (12), with those recesses having a geometry complementary to the stopper ends similar to the bonding head recesses (45). However, unlike the bonding head (41), each of these curing heads (51) is designed to draw heat away from the stopper and the bonded film portion in order to set the bond formed there-between. This curing process also occurs under pressure applied by the crank drive mechanism (43).

With reference again to FIGS. 1 and 2, the apparatus (100) further includes an inverter device (60). The inverter device is designed to remove four of the cork stoppers in a carriage (12) that has just emerged from the last of the curing heads (51)—with those corks having just had a coating of film applied to one of their ends (2)—and to transfer those corks via air-tubes (61) to another carriage at the start of the apparatus in such a way that those four corks are inverted and ready to undergo the same process at their opposite ends. The other four of the eight corks in that carriage—which have now had a film coating applied to both of their opposite ends—are ejected from the apparatus (100) into a bulk collection container (90). The apparatus typically also includes a device, such as an optical sensor (91), for keeping count of the number of finished corks ejected to the bulk container.

The apparatus (100) of the present invention operates in the following way. An empty carriage (12) is moved on the chain conveyor (11) to the start position of the apparatus where four fresh, uncoated cork-type stoppers (1) are loaded from the hopper (21) into four receptacles (13) at one side of the carriage. At the same time, four cork stoppers (1) which have had a film coating applied at one end thereof are loaded into the other four empty receptacles (13) on the opposite side of the carriage (12) via the air-tubes (61), such that their still-uncoated end (2) faces upwards. The chain conveyor (11) then transports the full carriage (12) to a position adjacent and beneath the film cutting device (30) which operates according the series of steps described with reference to FIGS. 3a to 3c. That is, it cuts discrete disc-shaped film portions and affixes a respective one of those film portions to the upward facing end (2) of each cork in the carriage.

The carriage (12) is then further advanced to the bonding and curing press (40,50), through which it advances in step-wise fashion such that the corks undergo a heated bonding operation and a three-stage curing operation. The four corks (1) which now have a film coating on just the upper one of their two opposite ends are returned via the air tubes (61) to the start position on the apparatus and inserted with their uncoated ends facing upwards in a new carriage (12). The other four corks, which now have a coating on both of their two opposite ends, are ejected to the bulk container (90) from which they may then be transferred for further processing, such as wax or silicon coating.

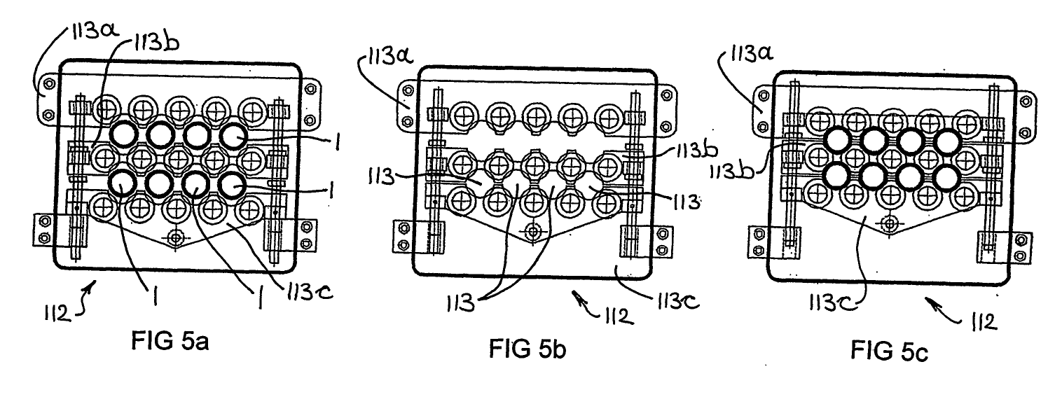

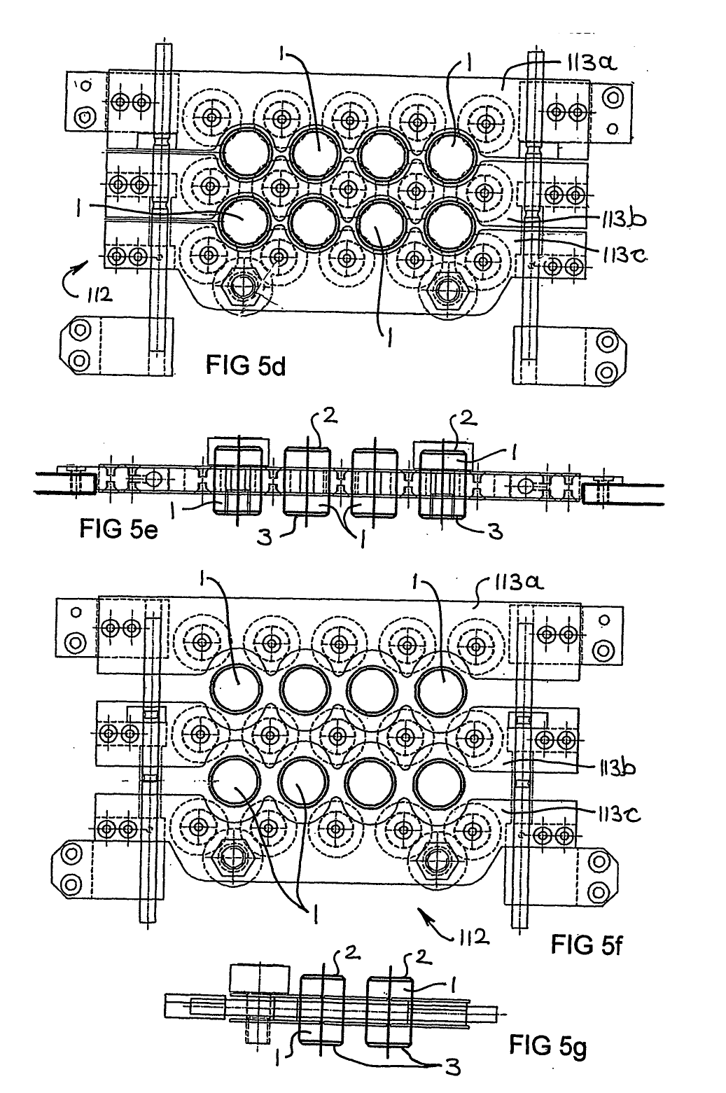

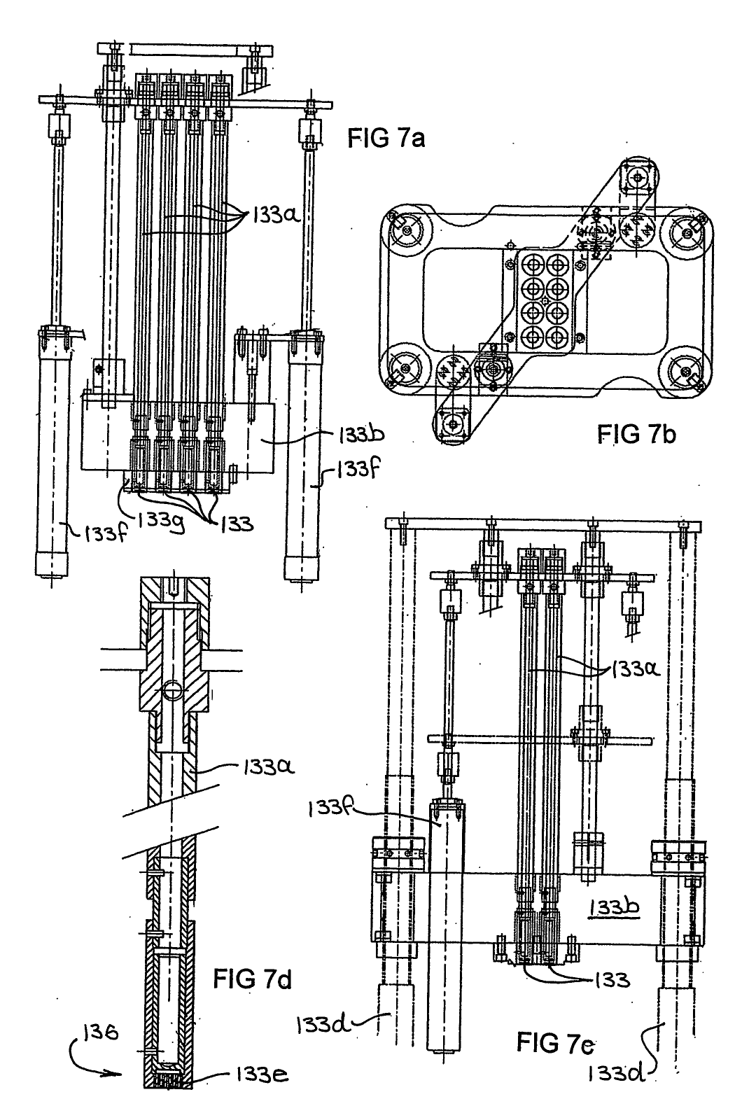

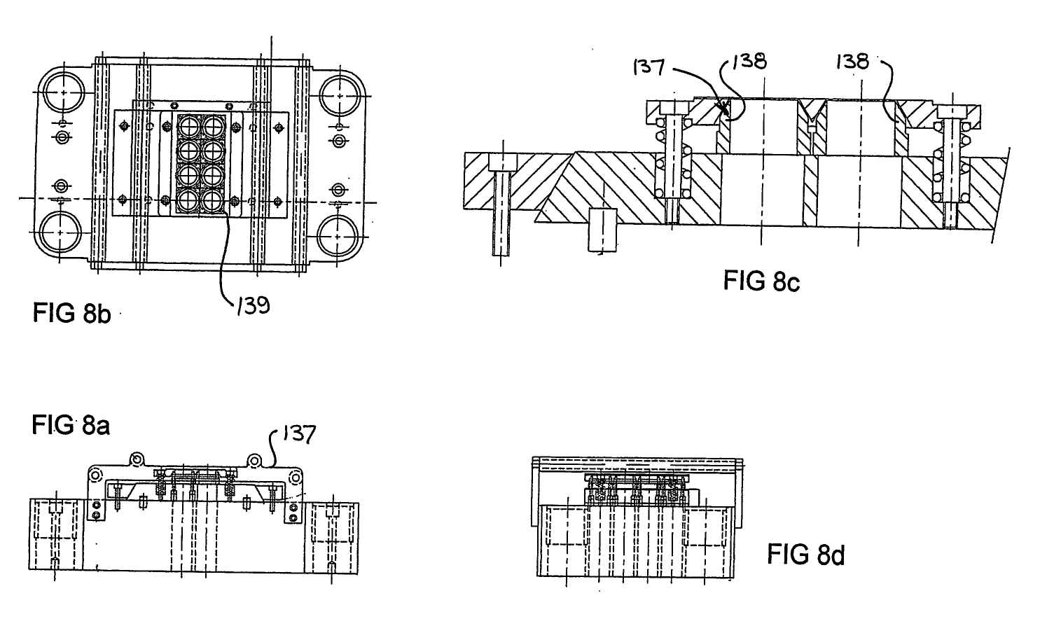

A description of the embodiment illustrated in FIGS. 5a to 9f will now be provided.

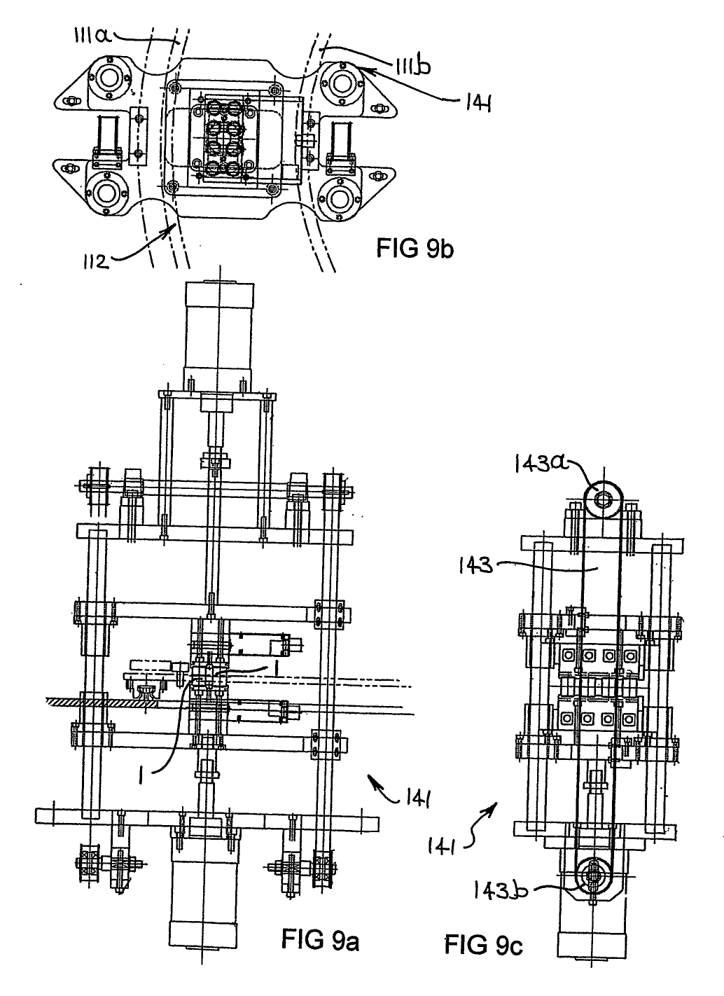

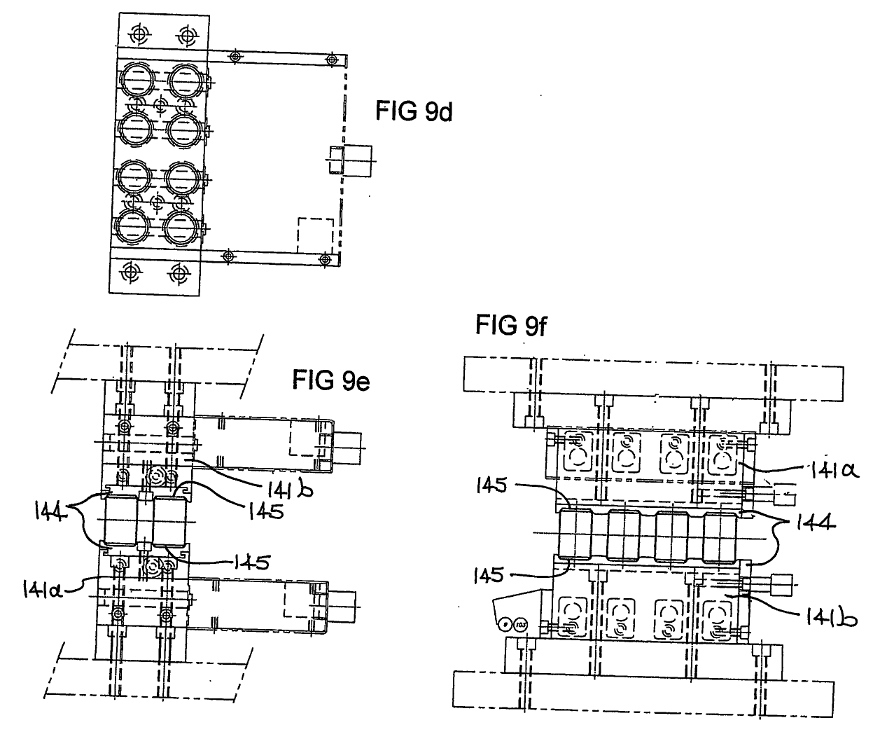

Referring particularly to FIGS. 5a to 5g, the apparatus includes a rotary conveyer means (110) for transporting the cork stoppers (1) through the apparatus. The conveyer means (110) includes a generally circular table (111) having a plurality of transport carriages (112) mounted on concentric rails (111a,b) provided about the table periphery (see FIG. 9b). Each of the carriages (112) defines eight holding receptacles (113). Each of the receptacles (113) is designed to receive a single stopper (1).

The carriage (112) includes a three-part clamp (113a,b,c) for accurately loading eight stoppers (1) into the receptacles (113). It is to be appreciated that both ends of the stoppers (1) are exposed when loaded in the carriages (112), thereby enabling treatment of both ends of the stoppers (1) without having to rotate or invert the stoppers (1) between the separate treatment of the stopper ends (2,3). The provision of the three-part claim (113,a,b,c) means that the corks are accurately aligned within the receptacles (113) irrespective of the diameters of the corks used. A loading device (not illustrated) similar to that illustrated in FIGS. 1 and 2 may be provided for loading the stoppers (1) into the carriages (112).

The table (111) is motor-driven such that it is caused to rotate about its axis (111a). The table (111) is rotated in a step-wise fashion about its axis (111a) in order to advance the stopper carriages (112) to precise positions within the apparatus at specific time intervals.

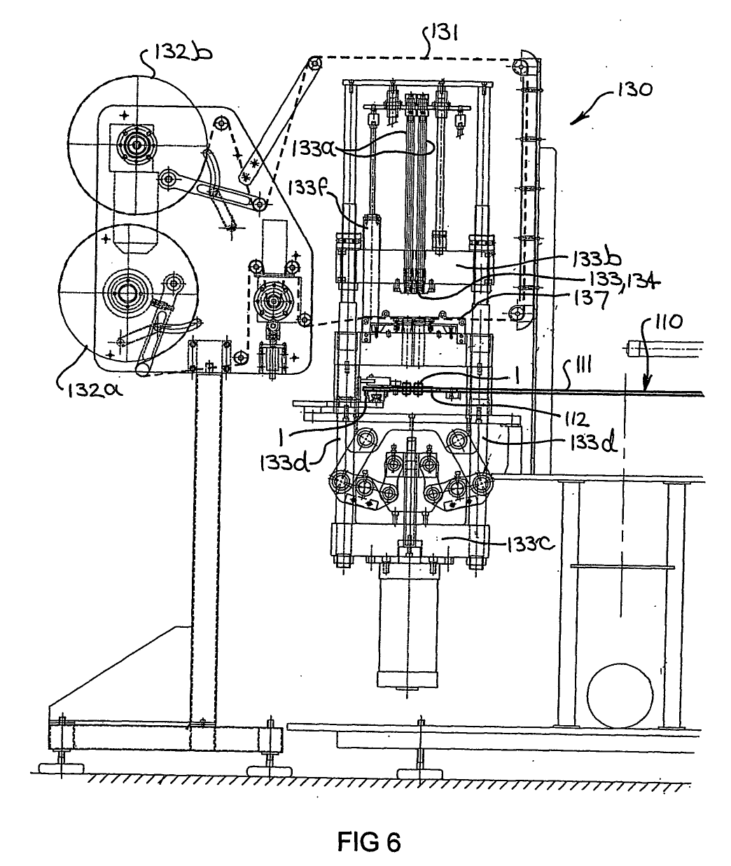

Referring to FIGS. 6 to 8d, the apparatus includes a device (130) designed to cut portions of film from a film web (131), with each of those cut film portions being sized and shaped to suit the upper ends (2) of the cork stoppers (1) held in the carriages (112). The film web (131) is provided on replaceable spools (132a,b). During operation of the apparatus the web (131) is advanced from the spool (132a) of new film to the spool (132b) of used film as the individual portions are cut from the web (131). The cutting device (130) has a cutting head (137) that includes eight circular blades or knives (138), with each knife or blade associated with a separate one of the stoppers (1) in the carriage (112) adjacent to the cutting device (130).

The generally cylindrical cork stoppers (1) are held in their receptacles (113) in the carriage (112). The stopper ends (2,3) each have a chamfered peripheral edge region and a substantially flat end surface (2,3). The cutting head (137) has circular blades or knives (138) for cutting disc film portions from the film web (131). The disc-shaped film portions are sized to substantially entirely cover the tapered ends (2,3) of the stoppers (1).

The cutting blades or knives (138) cut the disc film portions against a downwardly movable cutting on plate (1 33g). The plate (1 33g) is mounted to the underside of a mounting block (133b). The lower surface of the plate (133g) includes the end faces (133) of eight heated rods (133a). Each of the rod end faces (133) includes an electrical heating element (135) for heating the rod end faces (133).

The film web (131) extends between the upper ends (2) of the stoppers (1) and the block (1 33b).

Reference is now made particularly to FIG. 6. An actuator (not illustrated) is connected to a block (133c). Arms (133d) connect the block (133c) to the mounting block (133b). A downward movement of the block (133c) produces a like downward movement of the mounting block (133b). The mounting block (1 33b) is driven downwards such that each of the blades or knives (138) cuts a disc-like film portion from the web (131). Following this, the mounting block (133b) is driven further downwards by pneumatic cylinders (133f) to the extent that the end faces (133) of the rods (133a) press the disc-like film portions into contact with the upper ends (2) of the stoppers (1).

The disc-like film portions are retained in position on the end faces of the rods (133a) between the cutting stage and stopper pressing stage by the provision of a vacuum device (133e) provided in each of the rods (133a).

The end faces (133) of the rods (133a) are heated. The application of heat and pressure activates the adhesive properties of the inner layer of the polymer film to thereby fix the disc-like film portions to the ends (2) of the corks by adhesive tacking. Preferably the adhesive taking occurs at a temperature of between 90° C. and 120 C. Again, the ends (2) will typically undergo some compression during the heat tacking operation, and the degree of compression will typically depend on the extent to which the heated projecting faces (133) of the rods (133a) are pressed downwards. The extent of the downward travel of the end faces (133) may be adjusted by regulating the air pressure supplied to the pneumatic cylinders (133f) or by otherwise changing the location of the extended position. Following the above described operation, the stoppers (1) will each have disc-shaped portions of film (not shown) fixed to their upper ends (2) ready for final bonding. The shape of the cutting head (137) may be altered, if desired.

It is to be appreciated that the apparatus includes a second device (not illustrated) for treatment of the lower ends (3) of the stoppers (1) held in the carriages (112). It may be that both of the devices are combined for substantially simultaneous treatment of both ends (2,3) of the stoppers (1).

Although not illustrated in full, the apparatus includes a bonding press (141) and at least one curing press (not illustrated). The bonding and curing presses may be combined if desired. The bonding press (141) has heated opposed bonding heads (141a,b) and each curing press has cooled curing heads.

The opposed bonding heads (141a,b) are arranged for the substantially simultaneous bonding of both ends (2,3) of the stopper (1). The heads (141a,b) are reciprocally driven by a timing belt (143) and associated pulleys (143a,b).

Detail of the bonding heads (141a,b) are shown in FIGS. 9a to 9f of the drawings. The bonding heads (141a,b) include electric heating elements (144) and shaped recesses (145) adapted to receive the tapered ends (2,3) of the cork stoppers (1). The shaped recesses (145) are designed with substantially the same angles of taper as the ends of the stoppers (1). The belt mechanism (143) moves the heated bonding heads (141a,b) towards the stoppers (1) such that each end of the stoppers (1) are received within a respective one of the bonding head recesses (145). The heated bonding heads (141a,b) press the cut film portion discs—which are fixed at either ends (2,3) of the stoppers (1)—into intimate contact with the stopers (1) over the entire extent of the film portions. In so doing, the cork stoppers (1) will typically experience some compression, e.g. in the range of about 5 to 10 percent, and will be held for a period in the range of about 0.1 to 15 seconds, and more preferably in the range of about 0.1 to 5 seconds. During this period, the film portions and the ends (2,3) of the stoppers (1) are typically heated to at least 80° C., and more preferably to at least about 120° C. Yet more preferably, the film portions and the stopper ends (2,3) are heated to between 120° C. and 190° C. This heating again activates the adhesive properties of the film into intimate contact with the tapered ends (2,3) of the cork stoppers (1), enabling the film to bond coherently and consistently over the entire tapered ends (2,3).

Each cooling head (not illustrated) also has recesses for receiving the ends (2,3) of each cork stopper (1) in the adjacent carriages (112), with those recesses having a geometry complementary to the stopper ends (2,3) similar with the bonding head recesses (145). However, unlike the bonding heads (141a,b), each of the curing heads is designed to draw heat away from the stoppers (1) and the bonded film portions in order to set the bonds formed there-between. The curing process occurs under pressure from a timing belt.

The apparatus illustrated in FIGS. 5a to 9f operates in the following way. An empty carriage (112) is transferred by the rotary conveyor means (110) to he start position of the apparatus where eight fresh, uncoated cork-type stoppers (1) are loaded from a hopper (not illustrated) into eight receptacles (113). The conveyer means (110) then advances the full carriage (112) to a position adjacent and beneath the film cutting device (130), which cuts discrete disc-shaped portions and affixes a respective one of those film portions to the upper end (2) of each cork in the carriage (112). The conveyor means (110) then advances the carriage (112) to a second film cutting device (not illustrated) for cutting discrete disc-shaped portions and affixing a respective one of those film portions to the lower end (3) of each cork in the carriage (112).

The carriage (112) is then further advanced to the bonding and curing presses, through which it advances in step-wise fashion such that the corks undergo a heated bonding operation and at least one curing stage operation on both ends (2,3) of the corks (1) simultaneously.

The eight corks (1) now have film coated on both their upper (2) and lower (3) ends and are ejected to a bulk container from which they may be transferred for further processing, such as wax or silicon coating.

Advantageously, each of the above described processes takes place substantially independent of the length of the cork being treated.

The process described above cuts the web concentrically above the corks, which advantageously allows for the effective alignment of the disks on the cork ends.

Finally, it will be appreciated that various alterations and/or additions may be introduced into the particular construction and arrangement of parts specifically described with reference to the drawings without departing from the spirit or ambit of the present invention.

1. A method of applying a film coating to an end of a container stopper, including the steps of:
positioning the stopper with the said end adjacent a web of film;
cutting from the web a portion of film sized to suit said end of the stopper; and
bonding the film portion to the end of the stopper.

2. A method according to claim 1, wherein the step of positioning the stopper with the said end adjacent the web of film includes transporting or conveying the stopper to such a position.

3. A method according to claim 1, wherein the step of positioning the stopper with the said end adjacent the web of film includes orienting the stopper such that the end is adjacent the film web.

4. A method according to claim 1, wherein the step of cutting the film portion from the web includes the step of fixing the film portion relative to the end of the stopper.

5. A method according to claim 4, wherein the step of fixing the film portion relative to the end of the stopper comprises adhesively tacking the cut portion of the film to the end of the stopper over at least part of the area of the film portion.

6. A method according to claim 5, wherein the step of adhesively tacking the film portion to the end of the stopper includes applying heat to and pressing said part of the film portion into contact with the end of the stopper, said application of heat activating adhesive properties of the film portion.

7. A method according to claim 5, wherein the step of adhesively tacking the film portion to the end of the stopper includes applying an adhesive substance to the end of the stopper and pressing the at least park of the film portion into contact therewith.

8. A method of applying a film coating to an end of a container stopper, including the steps of:
providing a stopper having at least one end to be coated;
cutting from a web of film a portion of film sized to suit said end of the stopper;
applying the cut film portion to the end of the stopper; and bonding the film portion to the end of the stopper.

9. A method according to claim 8, wherein the film portion is pre-cut from the film web to be applied to the end of the stopper as a label-like element prior to the bonding step.

10. A method according to claim 1, wherein the step of bonding the film portion to the end of the stopper includes the step of applying heat over substantially the entire area of the film portion to activate adhesive properties of the film and pressing the heated film portion and the end of the stopper into contact with one another.

11. A method according to claim 10, wherein the adhesive is a hotmelt adhesive applied to the film by spraying or extrusion coating.

12. A method according to claim 1, wherein the step of bonding the film portion to the end of the stopper includes the step of applying adhesive to the end of the stopper and subsequently pressing the film portion and the end of the stopper into contact with one another.

13. A method according to claim 12, wherein the adhesive is a hotmelt adhesive applied to the end of the stopper prior to the portion of film being cut from the web.

14. A method according to claim 1, wherein the portion of film cut from the web is sized and shaped to substantially entirely cover the end of the stopper substantially without excess of film.

15. A method according to claim 10, wherein the step of pressing the film portion and the end of the stopper into contact with one another during the film-bonding step involves the use of a press or mandrel shaped to complement the geometry of the end of the stopper.

16. A method according to claim 15, including the step of heating the press or mandrel.

17. A method according to claim 1, including the step of curing the bond between film portion and the end of the stopper.

18. A method according to claim 17, wherein the step of curing the bond involves cooling the film portion and the end of the stopper to set the bond and ensure proper adhesion there-between.

19. A method according to claim 17, wherein the step of curing the bond includes pressing the film portion and the end of the stopper into contact with one another.

20. A method according to claim 19, wherein the pressing of the film portion and the end of the stopper into contact with one another during the curing step involves the use of a press or mandrel shaped to define the geometry of the end of the stopper.

21. A method according to claim 20, wherein the curing press/mandrel is cooled.

22. A method according to claim 1, wherein the container stopper has a substantially cylindrical body having two opposite ends,
and the method involves applying a film coating to each of said two ends of the stopper at substantially the same time.

23. A method according to claim 1, wherein the container stopper has a substantially cylindrical body having two opposite ends, and the method involves applying a film coating to one of said two ends of the stopper, inverting the stopper and then applying a film coating to the other of said two ends of the stopper.

24. A method according to claim 23, wherein the step of inverting the container stopper includes returning the stopper to a starting position for the method.

25. A container stopper having a film coating applied to at least one end thereof according to the method of claim 1.

26. A packaged product comprising a liquid in a container, the container including a container stopper according to claim 25.

27. An apparatus for applying a film coating to an end of a container stopper, the apparatus including:
means for positioning the stopper with the said end thereof adjacent a web of film;
means for cutting from the web a portion of film that is sized to suit the end of the stopper; and
means for bonding the film portion to the end of the stopper.

28. An apparatus according to claim 27, wherein the positioning means includes conveyor means for transporting the stopper to a position adjacent the web of film.

29. An apparatus according to claim 28, wherein the conveyor means includes a carriage for holding one or more of the stoppers and transporting the stopper(s) therein.

30. An apparatus according to claim 29, wherein the conveyor means includes a plurality of carriages, each of which is adapted to hold a group of stoppers.

31. An apparatus according to claim 29, wherein each stopper is held in a carriage with the end to be coated facing the film web.

32. An apparatus according to claim 28, wherein the conveyor means includes an endless belt or endless chain type conveyor.

33. An apparatus according to claim 28, wherein the conveyor means includes a rotary table or drum.

34. An apparatus according to claim 28, wherein the conveyor means is furthermore adapted to transport the stoppers from the cutting position adjacent the web of film to the bonding means.

35. An apparatus according to claim 27, wherein the apparatus further includes loading means for loading the stoppers into each carriage on the conveyor means.

36. An apparatus according to claim 35, wherein the loading means includes a bulk container, such as a hopper, adapted to channel or direct stoppers into holding receptacles in each carriage.

37. An apparatus according to claim 27, wherein the cutting means includes a cutting edge that defines the size and shape of the film portion to be cut from the web.

38. An apparatus according to claim 37, wherein the cutting edge is movable relative to the film web, and the cutting means also includes a surface against which the cutting edge bears as the film portion is cut from the web.

39. An apparatus according to claim 37, wherein the cutting means includes a recess adapted to receive said end of the stopper for locating the end relative to the cutting edge during cutting of the film.

40. An apparatus according to claim 27, wherein the web of film is provided on a spool, and the spool is adapted to be advanced after each cutting operation to provide a fresh film web for the next cutting operation.

41. An apparatus according to claim 27, wherein the cutting means includes means for fixing the cut film portion relative to the end of the stopper.

42. An apparatus according to claim 41, wherein the means for fixing the cut film portion relative to the end of the stopper comprises means for adhesively tacking the film portion to the end of the stopper over at least part of the area of the film portion.

43. An apparatus according to claim 42, wherein the tacking means comprises a mechanism adapted to apply an adhesive substance to the end of the stopper and to press at least part of the film portion into contact therewith.

44. An apparatus according to claim 42, wherein the tacking means comprises a mechanism adapted to apply heat to part of the film portion to activate adhesive properties of the film and to press the heated film portion into contact with the end of the stopper.

45. An apparatus according to claim 44, wherein the tacking mechanism includes a heated tacking head, which is movable to contact at least part of the film and to press that part of the film into contact with the end of the stopper.

46. An apparatus according to claim 45, wherein the tacking head is adapted to act substantially simultaneously with the cutting edge.

47. An apparatus according to claim 45, wherein the position of the tacking head is adjustable relative to the cutting edge such that it is possible to vary a diameter of the film portion disc cut from the web.

48. An apparatus according to claim 27, wherein the means for bonding the cut film portion to the end of the stopper includes means for applying heat over substantially the entire area of the cut film portion to activate adhesive properties of the film, and means for pressing the heated film portion and the end of the stopper into contact with one another.

49. An apparatus according to claim 48, wherein the bonding means includes a heated bonding head in the form of a press or mandrel adapted to apply pressure against the end of the stopper with the film at least partially affixed thereto.

50. An apparatus according to claim 49, wherein the bonding head includes a recess adapted to receive the end of the stopper, and the recess is sized and shaped to complement the geometry of the stopper end.

51. An apparatus according to claim 49, wherein the bonding head is movable relative to the stoppers sitting in each carriage, or vice versa.

52. An apparatus according to claim 27, wherein the means for bonding the cut film portion to the end of the stopper includes means for applying adhesive to the end of the stopper and subsequently pressing the film portion and the end of the stopper into contact with one another.

53. An apparatus according to claim 27, wherein the cutting means and the bonding means are combined in a single operating head.

54. An apparatus according to claim 53, wherein the cutting edge is provided on a cutting die, and wherein a base of the cutting die is provided with a shaped recess and is adapted to be heated, and to press the cut film portion into bonding contact with the end of the stopper body just as the die cuts the film portion from the web.

55. An apparatus according to claim 27, further including means for curing the bond between film portion and the end of the stopper.

56. An apparatus according to claim 55, wherein the bond curing means is adapted to cool the film portion and the end of the stopper to set the bond and ensure proper adhesion there-between.

57. An apparatus according to claim 56, wherein the curing means includes a curing head in the form of a press or mandrel shaped to define the geometry of the end of the stopper.

58. An apparatus according to claim 57, wherein the curing head press/mandrel includes recesses for receiving the ends of the stoppers, with the recesses sized and shaped to define the three-dimensional geometry of the end of the stopper.

59. An apparatus according to claim 27, wherein each container stopper has a substantially cylindrical body having two opposite ends, and wherein the apparatus further includes means for inverting each stopper and then applying a film coating to the other of said two ends of the stopper.

60. An apparatus according to claim 59, wherein the inverting means comprises a mechanism for extracting the container stoppers from their conveyor means carriage and returning the stoppers to a starting position in a different carriage.

61. An apparatus according to claim 27, wherein each container stopper has a substantially cylindrical body having two opposite ends, and wherein the apparatus is adapted to apply a film coating to each of the opposite ends of the stopper body substantially simultaneously.

62. An apparatus according to claim 28, wherein the conveyor means is adapted to eject the stoppers to a bulk container after the application of the film coating to the end(s) thereof is completed.
